(19) United States
(12) Patent Application Publication
(10) Pub. No.: US 2002/0031930 A1
(43) Pub. Date: Mar. 14, 2002

(54) Bi-metallic pin socket for lamps

(76) Inventor: Donald Metz, East Syracuse, NY (US)

Correspondence Address: SUGHRUE, MION, ZINN, MACPEAK & SEAS, PLLC, 2100 Pennsylvania Avenue, N.W., Washtington, DC, 20037-3213, US

(21) Appl. No.: 09/911,711

(22) Filed: Jul. 25, 2001

Related U.S. Application Data
(60) Provisional application No. 60/220,653, filed on Jul. 25, 2000.

(51) Int. Cl. H01R 13/20

(52) U.S. Cl. 439/161

(57) ABSTRACT

A bi-metallic pin socket for receiving the pins of a lamp is provided with two curved apertures each having a narrow end and a wide end. An elongated bi-metallic element of uniform thickness having a curvature matching the curvature of the aperture is disposed in each aperture for engagement with a respective lamp pin. The socket is provided with an angled recess at the narrow end of each aperture and each bi-metallic element has an angled end portion secured in a respective recess.

### BACKGROUND OF THE INVENTION

The present invention is directed to a bi-metallic pin socket for lamps wherein a bi-metal strip is used to increase contact force between the pin and the socket contact as a result of lamp heat and thereby prevent failure. 50 watt and higher halogen two pin lamps cause high pin temperatures, especially in the G5.3 and smaller even when based in MR 16 or MR 11 reflectors. Lamp contacts have to take a high current because halogen two pin lamps are usually 24 volts or less, requiring a minimum current rating of 2 AMPS contact. Present sockets used for G5.3 designs and smaller two pin lamps have spring contacts that anneal with the lamp heat reducing contact pressure causing high resistance contacts that increase the heat even more. The increased heat speeds up the molybdinum foil seal failure mode of two pin quartz halogen lamps. In 150 watt two pin lamps, a major cause of failure is the molybdinum foil seal.

The patent to Barnhart (U.S. Pat. No. 3,112,146) uses a bimetallic leaf spring which provides a forcible electrical connection between the socket contact and the pin of an electrical connector throughout a wide range of temperatures.

### SUMMARY OF THE INVENTION

The present invention provides a new and improved bi-metallic pin socket wherein the bi-metallic element is connected directly to the electrical lead-in wire for the socket. The bi-metallic element may engage one side of a lamp pin or have a U-shaped configuration engaging opposite sides of the pin.

The specific nature of the invention, as well as advantages thereof, will clearly appear from the following description and from the accompanying drawings.

### BRIEF DESCRIPTION OF THE DRAWINGS

FIG. 1 is an exploded perspective view of a two pin lamp and bi-metallic socket assembly.

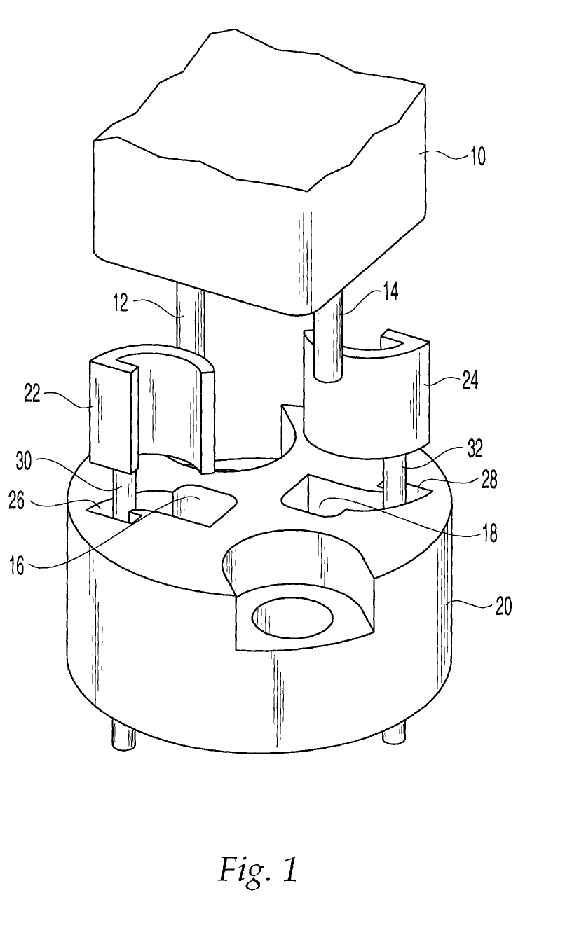

FIG. 2 is a plan view of the socket having bi-metallic contacts and the lamp pins.

FIG. 3 is a perspective view of the assembled bi-metallic socket assembly with the two pin lamp partially inserted in the socket.

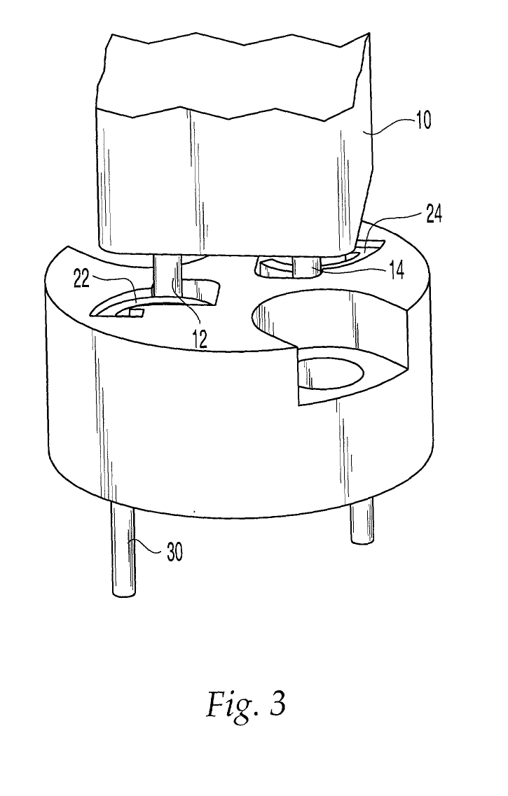

### DETAILED DESCRIPTION OF THE INVENTION

A halogen lamp 10 is provided with two contact pins 12 and 14 adapted to be inserted in apertures 16 and 18 respectively in a socket 20. A pair of bi-metallic elements 22 and 24 are adapted to be secured in apertures 26 and 28, respectively, which are located adjacent to and in communication with the apertures 16 and 18. Lead in wires 30 and 32 are connected to the bi-metallic elements so that the bi-metallic elements 22 and 24 act as the electrical contacts of the socket.

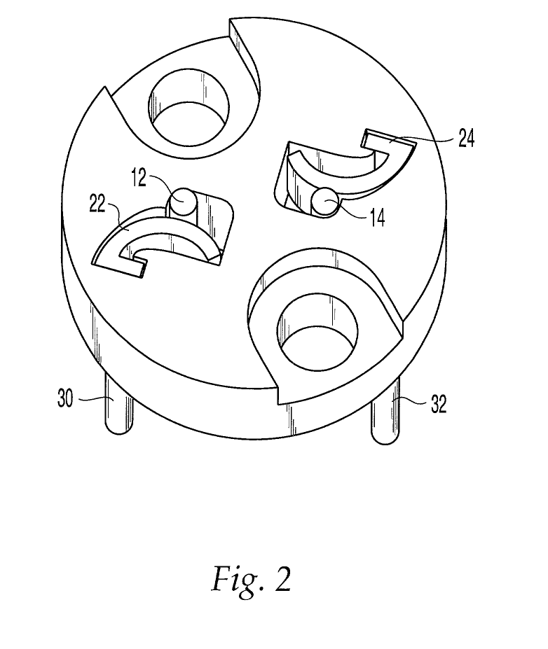

When the bi-metallic elements 22 and 24 are secured within their respective apertures by adhesives or other suitable means, and the lamp pins 12 and 14 are located in adjacent apertures in contact with the elements 22 and 24 as best seen in FIG. 2, electrical current can flow from the lead in wires 30 and 32 through the bi-metallic contacts 22 and 24 and the pins 12 and 14 to the halogen lamp 10. The heat generated by the flow of current causes the bi-metallic elements 22 and 24 to bend in the direction of the pins 12 and 14 to increase the pressure therebetween.

While the preferred embodiment has been described, variations thereto will occur to those skilled in the art within the scope of the present inventive concepts.

What is claimed is:

1. A bimetallic pin socket for a lamp comprising a socket having two spaced apart apertures therein having a curved shape with a wide end and a narrow end, a pair of curved, bi-metallic elements located in said apertures, respectively, with each curved element having a substantially uniform thickness wherein an outer curved surface of each element is disposed in an engagement with an outer curved surface of each aperture leaving a gap between an inner curved surface of the element and an inner curved surface of the aperture for reception of a lamp pin contact, said bi-metallic elements being configured to apply an increased pressure on said contact pins upon an increase in temperature.

2. A bi-metallic pin socket as set forth in claim 1 wherein each aperture has an angled recess adjacent the narrow end thereof and each element has a complimentary angled portion at one end secured in a respective angled recess.

3. A bi-metallic pin socket as set forth in claim 1 wherein electrical lead wires are connected to said bi-metallic elements respectively.
